(19) United States
(12) Patent Application Publication
(10) Pub. No.: US 2013/0290653 A1
(43) Pub. Date: Oct. 31, 2013

(54) LOG RECORDING APPARATUS

(71) Applicant: Tamotsu Hattori, Chiyoda-ku (JP)

(72) Inventor: Tamotsu Hattori, Chiyoda-ku (JP)

(73) Assignee: MITSUBISHI ELECTRIC CORPORATION, Chiyoda-ku, Tokyo (JP)

(21) Appl. No.: 13/979,591

(22) PCT Filed: Feb. 9, 2011
(86) PCT No.: PCT/JP2011/052788

§ 371 Date: Jul. 12, 2013

(51) Int. Cl. G06F 12/00

(52) U.S. Cl. CPC G06F 12/00
USPC 711/154

(57) ABSTRACT

To efficiently record logs, a log recording apparatus includes a log recording memory, an access control unit that acquires contents of an access from a CPU to a memory space, a log-recording-condition storage unit that has a log recording condition stored therein, and a log-recording-condition determination unit that determines, every time the access control unit acquires the access contents, whether the acquired access contents satisfy the log recording condition stored in the log-recording-condition storage unit. The access control unit is configured to store access contents determined as satisfying the log recording condition by the log-recording-condition determination unit in the log recording memory, and does not store access contents determined as not satisfying the log recording condition by the log-recording-condition determination unit in the log recording memory.

### FIELD

The present invention relates to a log recording apparatus that is included in an embedded controller.

### BACKGROUND

In development using an embedded controller, acquisition of logs of I/O accesses has been widely performed for failure analysis and performance measurement. The acquisition of logs is generally performed by adding a log acquisition description to software and thus an extra process is added to processes that are to be essentially performed, which reduces processing performance of a CPU (Central Processing Unit). Accordingly, when products are commercialized, the log acquisition description is usually invalidated to secure the CPU processing performance.

However, when the log acquisition description is invalidated, the failure analysis cannot be performed and thus it is difficult to perform the failure analysis after the products have been shipped. On the other hand, when the log acquisition description is validated, it is disadvantageous that the CPU processing performance is reduced and that a CPU having sufficient processing performance needs to be used. Accordingly, a log recording apparatus is required that can acquire logs for performing the failure analysis without reducing processing performance of a CPU.

For example, according to a technique disclosed in Patent Literature 1, an I/O log recording memory is provided separately from a main memory, the I/O storage memory is connected to an I/O memory control circuit, and when an I/O access cycle occurs in a CPU, the I/O memory control circuit responds to the corresponding access and simultaneously stores a date and a time of occurrence of the access, an address, and data in the I/O log recording memory. Consequently, the main memory is not consumed and a decrease in processing performance of the CPU can be prevented.

### CITATION LIST

### Patent Literature

Patent Literature 1: Japanese Patent Application Laid-open No. 2000-66966

### SUMMARY

### Technical Problem

However, according to the technique described in Patent Literature 1, when an occurred access is an I/O access, an I/O log is always recorded for the access. Accordingly, there is a problem in that when I/O accesses frequently occur or when log recording is performed for a long period of time, the capacity of the I/O log recording memory becomes insufficient and required logs cannot be acquired. On the other hand, when the capacity of the I/O log recording memory is increased, the quantity of I/O logs is also increased and thus it is difficult to find a causative I/O log at the time of failure analysis. Furthermore, because an increase in the I/O log recording memory disadvantageously leads to an increase in costs of the memory, the I/O log recording memory cannot be unnecessarily increased and the quantity of acquirable I/O logs is restricted.

The present invention has been achieved in view of the above problems, and an object of the invention is to provide a log recording apparatus that can efficiently record logs.

### Solution to Problem

In order to solve the above problem and in order to attain the above object, a log recording apparatus of the present invention includes: a log recording memory; an access control unit that acquires contents of an access from a CPU to a memory space; a log-recording-condition storage unit that has a log recording condition stored therein; and a log-recording-condition determination unit that determines, every time the access control unit acquires the access contents, the acquired access contents satisfy the log recording condition stored in the log-recording-condition storage unit. The access control unit stores access contents determined as satisfying the log recording condition by the log-recording-condition determination unit in the log recording memory, and does not store access contents determined as not satisfying the log recording condition by the log-recording-condition determination unit in the log recording memory.

### Advantageous Effects of Invention

The log recording apparatus according to the present invention does not cause any overhead in a CPU, can efficiently use a log recording memory, and thus can efficiently record logs.

### BRIEF DESCRIPTION OF DRAWINGS

FIG. 1 depicts a configuration of an embedded controller to which a log recording apparatus according to an embodiment of the present invention is applied.

FIG. 2 is an explanatory diagram of an example of a data structure of a log recording condition.

FIG. 3 is a flowchart for explaining an operation of the embedded controller to which the log recording apparatus according to the embodiment of the present invention is applied.

FIG. 4 is an example of a program.

FIG. 5 is an example of a program in a case where log recording is performed using a program.

FIG. 6 depicts a log that is recorded in a log recording memory by applying the embodiment of the present invention.

FIG. 7 depicts a log when logs relating to accesses are all recorded.

FIG. 8 is another configuration example of the embedded controller to which the log recording apparatus according to the embodiment of the present invention is applied.

### DESCRIPTION OF EMBODIMENTS

Exemplary embodiments of a log recording apparatus according to the present invention will be explained below in detail with reference to the accompanying drawings. The present invention is not limited to the embodiments.

### Embodiment

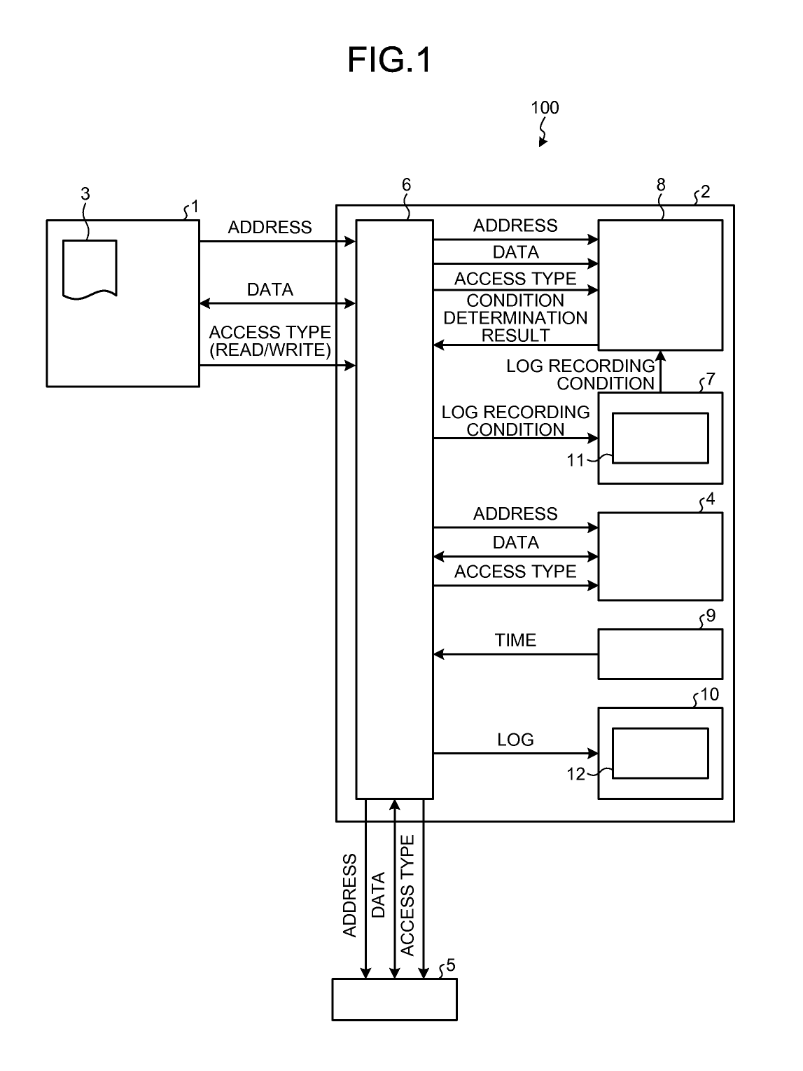

FIG. 1 depicts a configuration of an embedded controller to which a log recording apparatus according to an embodiment of the present invention is applied. As shown in FIG. 1, an embedded controller 100 includes a CPU 1, an ASIC (Application-Specific Integrated Circuit) 2, an internal circuit 4, an external circuit 5, an access control unit 6, a log-recording-condition storage unit 7, a log-recording-condition determination unit 8, a timing unit 9, and a log recording memory 10.

The CPU 1 is an arithmetic unit that executes a program 3 for controlling the embedded controller 100. Based on the program 3, the CPU 1 executes an access to the internal circuit 4 incorporated in the ASIC 2 or to the external circuit 5 via the ASIC 2.

The ASIC 2 is an integrated circuit that is accessed from the CPU 1 to perform various processes designed to realize an object of the embedded controller 100, and functions as the log recording apparatus of the present embodiment that records a log relating to an access from the CPU 1.

The internal circuit 4 and the external circuit 5 are accessed from the CPU 1 to realize a part of functions for realizing the object of the embedded controller 100. The internal circuit 4 is connected to the access control unit 6 in the ASIC 2, and the external circuit 5 is connected to the access control unit 6 at a position outside the ASIC 2.

The access control unit 6 responds to an access from the CPU 1 and performs control of storing contents of the access as a log in the log recording memory 10 based on a determination result of the log-recording-condition determination unit 8.

The log-recording-condition storage unit 7 is a storage device that holds a condition (a log recording condition 11) used for determining whether to record an access from the CPU 1 as a log, and is configured by, for example, a register or a small memory.

The internal circuit 4 and the external circuit 5 each include a storage device such as a register or a memory, and the storage devices are mapped in a memory address space that is recognizable by the CPU 1. The CPU 1 reads/writes data from/in the corresponding storage device mapped in the memory address space, thereby accessing the internal circuit 4 or the external circuit 5. That is, contents of an access performed by the CPU 1 via the ASIC 2 include an access destination address, access target data, and an access type that indicates whether the access is a read access or a write access. The log recording condition 11 specifies a condition for log recording by using the access destination address, the access target data, the access type, or a combination thereof.

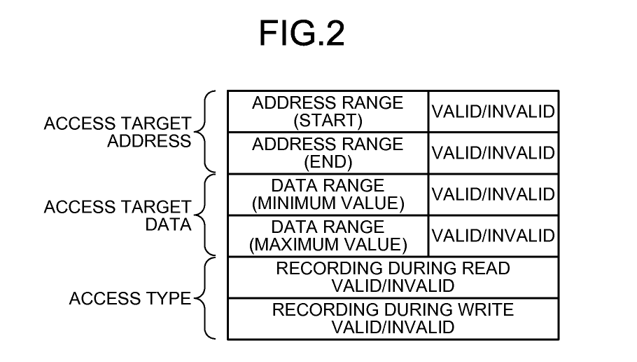

FIG. 2 is an explanatory diagram of an example of a data structure of the log recording condition 11 held in the log-recording-condition storage unit 7. As shown in FIG. 2, the log recording condition 11 includes a field for specifying the start and the end of an access-target address range, a field for specifying the minimum value and the maximum value of an access-target data range, and a field for specifying an access type. A flag is set in each of the field in which the address range is described and the field in which the data range is described. The flag specifies whether to validate or invalidate a value set for each of the fields. Furthermore, a flag that specifies whether to validate or invalidate log recording at the time of read and a flag that specifies whether to validate or invalidate log recording at the time of write are stored in the field for specifying the access type.

With the log recording condition 11 having this data structure, a user can record logs in a condition that is set for each of the access-target address range, the data range, and the access type or in a condition of a combination thereof. For example, by setting the start of an access-target address range to a 100th address and the end thereof to a 200th address, validating the start and end of the address range, and setting the access type to write, when a write access to the address range occurs, the write access contents can be log-recorded. By setting a data range having the minimum value of 1 and the maximum value of 10 and validating the minimum value and the maximum value of the data range in addition to setting of the above address range and the above access type, when a write access of writing data of the set data range in the address range occurs, the write access contents can be log-recorded. It suffices that the user sets an address range, a data range, and an access type that are particularly focused on for failure detection or performance measurement among accesses that may occur during execution of the program 3. Plural types of the log recording condition 11 can be set.

Contents recorded as a log include, for example, an access destination address and an access type. When the access type is write, data to be written can be included in the contents. When the access type is read, read data can be included in the contents.

The log-recording-condition determination unit 8 is a circuit that determines whether an access from the CPU 1 is an access that is to be recorded as a log based on the log recording condition 11 set in the log-recording-condition storage unit 7.

The timing unit 9 is a counter that counts a time. The access control unit 6 acquires an access time from the timing unit 9 when receiving an access from the CPU 1.

The log recording memory 10 is a memory device in which access contents from the CPU 1 are stored as a log (a log 12).

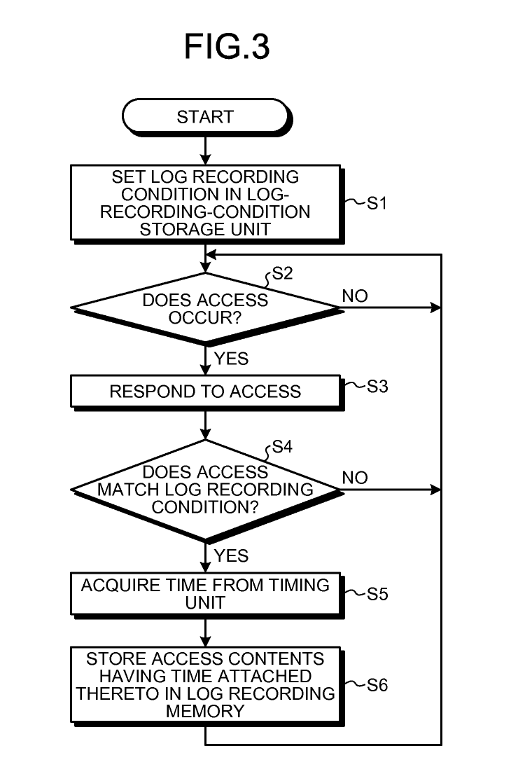

FIG. 3 is a flowchart for explaining an operation of the embedded controller 100 to which the log recording apparatus according to the embodiment of the present invention is applied.

At the start of the operation, the CPU 1 executes the program 3, thereby setting the log recording condition 11 in the log-recording-condition storage unit 7 (Step S1). After the log recording condition 11 is set, the access control unit 6 monitors an access from the CPU 1 to the internal circuit 4 or the external circuit 5 (NO at Step S2). When an access occurs (YES at Step S2), the access control unit 6 transmits a response to reception of the access to the CPU 1 (Step S3). Meanwhile, the log-recording-condition determination unit 8 determines whether the access matches the log recording condition 11 set in the log-recording-condition storage unit 7 (Step S4). Specifically, the log-recording-condition determination unit 8 determines whether the access destination address of the access is included in the address range set in the log recording condition 11, whether data read by the access or data to be written by the access included in the data range set in the log recording condition 11, and whether the type of the access matches the access type set in the log recording condition 11. When a plurality of log recording conditions 11 are set, the log-recording-condition determination unit 8 determines whether the access from the CPU 1 matches any one of the set log recording conditions 11. When the access from the CPU 1 does not match the condition (NO at Step S4), the process proceeds to Step S2.

When the access from the CPU 1 matches the log recording condition 11 (YES at Step S4), the access control unit 6 acquires the time of the access from the timing unit 9 (Step S5) and stores the access contents having the acquired time attached thereto in the log recording memory 10 (Step S6). The process then proceeds to Step S2.

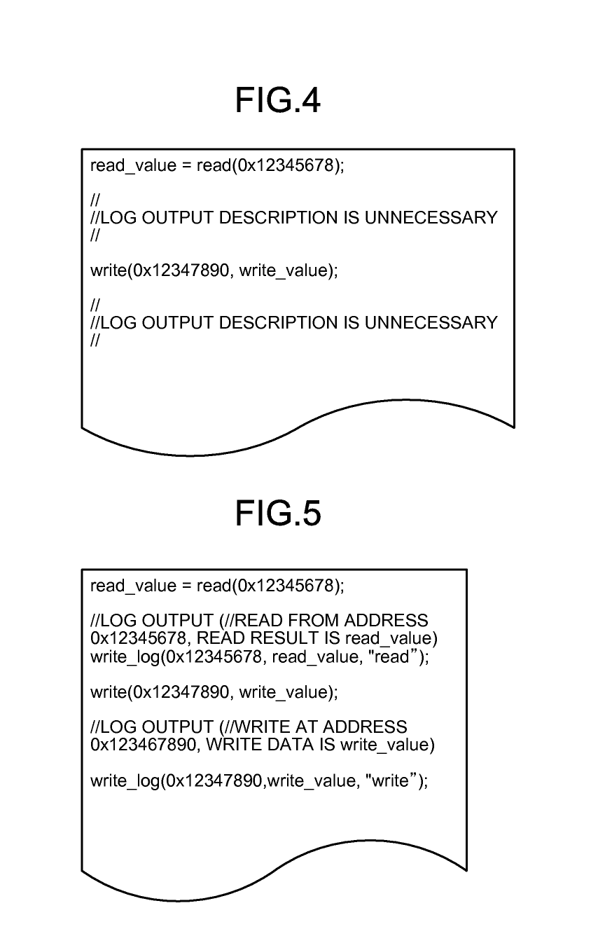

Next, effects of the embodiment of the present invention are explained with reference to FIGS. 4 to 7. FIG. 4 is an example of the program 3. FIG. 5 is an example of a program in a case where log recording is performed using a program, for comparison with the embodiment of the present invention.

As shown in FIG. 5, when log recording is performed using a program, a log output description is embedded in the program. Because the CPU needs to perform the log output description in addition to a description for a usual operation in the program, overhead corresponding to performance of the extra description occurs. In contrast, according to the embodiment of the present invention, log recording can be performed with no log recording description in the program 3, as shown in FIG. 4. That is, overhead due to log recording does not occur in the CPU 1. Accordingly, log recording can be performed also after products have been shipped, so that the logs 12 accumulated in the log recording memory 10 can be used for failure analysis when a failure occurs after the products have been shipped.

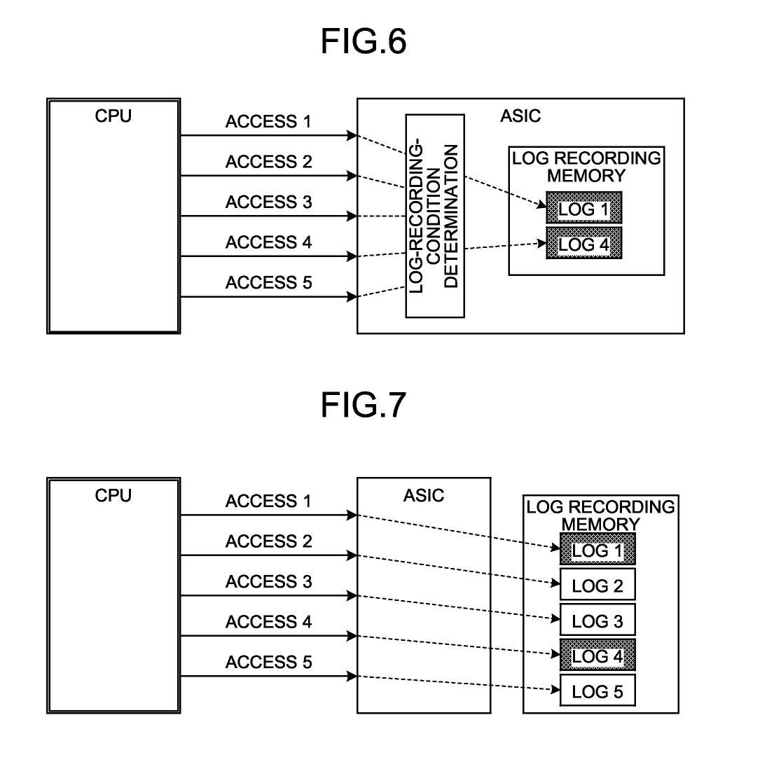

FIG. 6 depicts the logs 12 that are recorded in the log recording memory 10 by applying the embodiment of the present invention. FIG. 7 depicts logs in a case where logs relating to accesses are all recorded, for comparison with the embodiment of the present invention.

As shown in FIG. 7, in the case where logs relating to accesses are all recorded, when five accesses occur, five logs corresponding the respective accesses are all recorded. In contrast, according to the embodiment of the present invention, only logs that match the set contents of the log recording condition 11 (logs relating to an access 1 and an access 4 in this example) are stored in the log recording memory 10, as shown in FIG. 6. That is, according to the embodiment of the present invention, because logs can be narrowed down and required logs can be recorded, the log recording memory 10 can be efficiently used. Accordingly, when log recording is performed also after products have been shipped, log recording can be performed with the log recording memory 10 having smaller capacity than that in the case where logs relating to all accesses are recorded.

As explained above, the embodiment of the present invention is configured to include the log recording memory 10, the access control unit 6 that acquires contents of an access from the CPU 1 to a memory space, the log-recording-condition storage unit 7 that has the log recording condition 11 stored therein, and the log-recording-condition determination unit 8 that determines, every time the access control unit 6 acquires the access contents, whether the acquired access contents satisfy the log recording condition 11 stored in the log-recording-condition storage unit 7. Furthermore, the access control unit 6 is configured to store access contents determined as satisfying the log recording condition 11 by the log-recording-condition determination unit 8 in the log recording memory 10 and does not store access contents determined as not satisfying the log recording condition 11 by the log-recording-condition determination unit 8 in the log recording memory 10. Consequently, any overhead does not occur in the CPU 1 and the log recording memory 10 can be efficiently used. That is, logs can be efficiently recorded.

Because the log recording condition 11 is specified by using an access destination address, a data value, an access type, or a combination thereof, a user can flexibly set a condition for log recording.

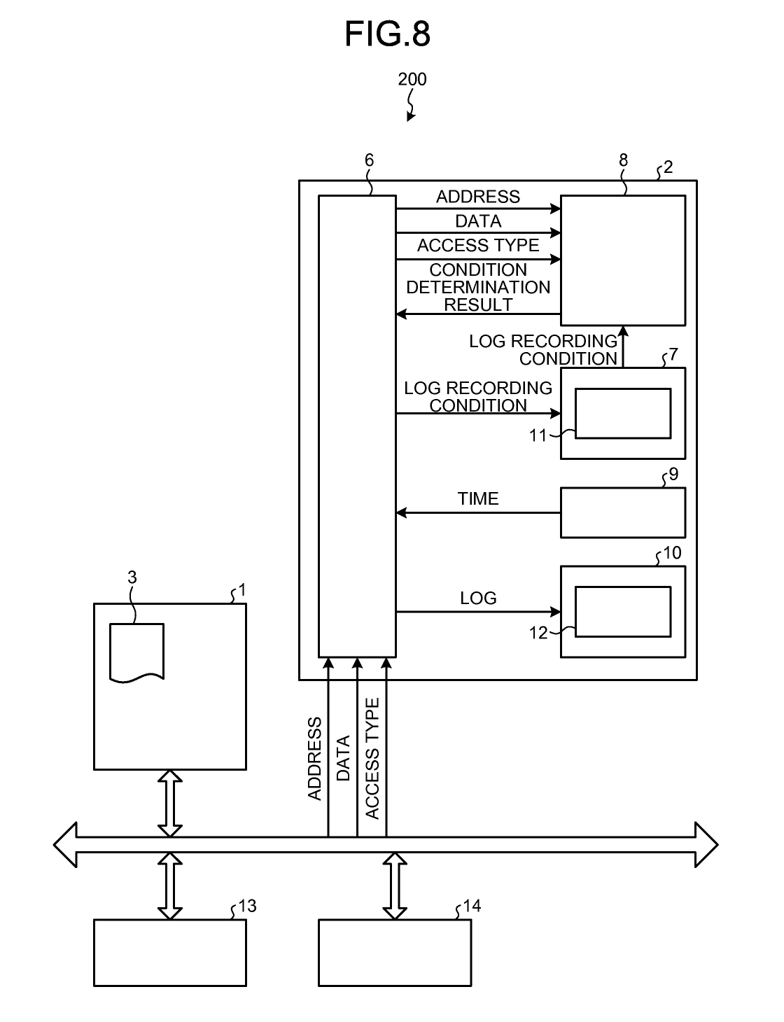

While it has been explained above that the internal circuit 4 and the external circuit 5 are connected via the access control unit 6, it is also possible that peripheral circuits 13 and 14 having functions corresponding to the internal circuit 4 and the external circuit 5, respectively, are connected via a bus to the CPU 1, the ASIC 2 serving as the log recording apparatus reads an address, data, and an access type through the bus, and the read contents are log-recorded, as in an embedded controller 200 shown in FIG. 8.

While it has been explained that the log recording apparatus is realized by using the ASIC 2, a function corresponding to the ASIC 2 can be realized by using an FPGA (Field Programmable Gate Array) or a CPLD (Complex Programmable Logic Device).

Furthermore, the log recording memory 10 can be configured by a removable memory device such as a flash memory card. Consequently, when analyzing logs, the user can remove the log recording memory 10 and read logs from the removed log recording memory 10 in a personal computer or the like for analysis, and therefore convenience for the user is improved.

### REFERENCE SIGNS LIST

1 CPU
2 ASIC
3 program
4 internal circuit
5 external circuit
6 access control unit
7 log-recording-condition storage unit
8 log-recording-condition determination unit
9 timing unit
10 log recording memory
11 log recording condition
12 log
13, 14 peripheral circuit
100, 200 embedded controller

1. A log recording apparatus comprising:
a log recording memory;
an access control unit that acquires contents of an access from a CPU to a memory space;
a log-recording-condition storage unit that has a log recording condition stored therein; and
a log-recording-condition determination unit that determines, every time the access control unit acquires the access contents, whether the acquired access contents satisfy the log recording condition stored in the log-recording-condition storage unit, wherein
the access control unit stores access contents determined as satisfying the log recording condition by the log-recording-condition determination unit in the log recording memory, and does not store access contents determined as not satisfying the log recording condition by the log-recording-condition determination unit in the log recording memory.

2. The log recording apparatus according to claim 1, wherein the log recording condition is specified by using an access destination address, a data value, an access type, or a combination thereof.

3. The log recording apparatus according to claim 1, wherein the log recording memory is a removable memory device.

4. The log recording apparatus according to claim 1, wherein the access control unit is connected via a bus to the CPU, and acquires an address, data, and an access type that are transmitted from the CPU to the bus.
